(19) United States
(12) Patent Application Publication
(10) Pub. No.: US 2020/0202187 A1
(43) Pub. Date: Jun. 25, 2020

(54) PRINTING SYSTEM, INFORMATION PROCESSING DEVICE AND DATA PROCESSING METHOD

(71) Applicant: KONICA MINOLTA, INC., Tokyo (JP)

(72) Inventor: Yuhei KURIGATA, Tokyo (JP)

(73) Assignee: KONICA MINOLTA, INC., Tokyo (JP)

(21) Appl. No.: 16/597,921

(22) Filed: Oct. 10, 2019

(30) Foreign Application Priority Data
Dec. 19, 2018 (JP) 2018-237404

(51) Int. Cl. G06K 15/02; G06F 3/12

(52) U.S. Cl. CPC G06K 15/1865; G06F 3/1208; G06K 15/1836; G06F 3/1248

(57) ABSTRACT

A printing system which prevents a printer productivity decline due to a bottleneck in time required to read raster image data from an HDD. In the system, a printer controller includes: a data format selector which stores at least either intermediate data or raster image data generated by a data processor in the HDD in a data format selected according to PDL data and selects the data format to be read from the HDD; and an image synthesizer which sends the printing image data obtained by synthesizing the raster image data obtained by rasterization of the intermediate data read from the HDD in the format selected by the data format selector or the raster image data read from the HDD for each page, to the printer. The printer includes a print engine which prints an image on a recording material according to the printing image data from the printer controller.

### CROSS-REFERENCE TO RELATED APPLICATIONS

The entire disclosure of Japanese Patent Application No. 2018-237404, filed on Dec. 19, 2018, is incorporated herein by reference in its entirety.

### BACKGROUND

### Technological Field

The present invention relates to a printing system, an information processing device, and a data processing method.

### Description of the Related Art

In the recent years, the speed of digital printing has been increasing. One of the major advantages of digital printing is that variable data printing can be made in which the content to be printed can be changed for each copy. One typical example of variable data printing is direct mail printing in which many letters, each with the same content, are printed with a different name and a different address on each letter. In order to achieve variable data printing, a printer controller connected to a printer performs RIP (Raster Image Processor) processing in real time for each direct mail copy.

Generally, the RIP processing speed depends on the processing capability of the CPU (Central Processing Unit) which performs RIP processing. The CPU is a processor which is included in the printer controller. In the recent years, with the growing tendency towards higher processing speeds of digital printers, the increase in the CPU processing capability has been demanded. However, one problem is that when the CPU processing capability is increased, the printer controller is more costly. Another problem is that since the RIP processing time changes depending on the page content, the productivity of the printer is unstable.

As a solution to these problems, the following method has been adopted: the pages in all copies are previously RIP-processed and the RIP-processed page data (raster image data) is stored in a large capacity storage such as an HDD (Hard Disk Drive). Next, this method will be explained referring to FIG. 1.

FIG. 1 is a block diagram which shows an example of the process in which an existing printer controller 100 stores raster image data in an HDD 102.

In the printer controller 100, a CPU 101, the HDD 102, and a DMA (Direct Memory Access) controller 103 are all connected through a system bus 104.

The CPU 101 performs an interpretation process to interpret the PDL (Page Description Language) data received from a client terminal (not shown) and generate intermediate data and a rasterization process to convert the intermediate data into a raster image. The interpretation process and rasterization process are collectively called RIP processing.

Then, the CPU 101 stores the raster image data generated by performing RIP processing in advance, in the HDD 102 through the system bus 104. Performing RIP processing in advance as mentioned above is here called “pre-RIP”. This method has been considered to increase productivity because the CPU 101 performs RIP processing before starting printing and need not perform RIP processing at the start of printing.

As a technique which converts page data into raster image data, for example, the technique disclosed in Patent Literature 1 (JP-A-2017-87583) is known. Patent Literature 1 describes that “in reprinting, on a page-by-page basis, RIP time for a target page as described in the list is compared with the printing preparation time required to complete preparations for printing of the target page, which is calculated from the maximum processing speed of the print engine, and according the comparison result, a determination is made as to whether each page is a page whose raster data is to be retained in the storage or a page whose raster data is to be removed from the storage.”

### CITATION LIST

### Patent Literature

Patent Literature 1: JP-A-2017-87583

### SUMMARY

Next, the process in which the existing printer controller 100 reads raster image data will be explained referring to FIG. 2.

FIG. 2 is a block diagram which shows an example of the process in which the existing printer controller 100 reads raster image data from the HDD 102 and outputs it.

In printing, separately from processing by the CPU 101, the DMA controller 103 directly reads the raster image data stored in the HDD 102 and sends it to a print engine. This method has been considered to enable full utilization of the production capability of the print engine for printing and thereby solve the problem of unstable productivity which is caused by insufficiency in the RIP processing performance of the CPU 101.

However, generally, a read-out band in the read bus interface (I/F) 105 for reading from the HDD 102 (data read amount per unit time) is narrower than in other bus interfaces. For this reason, when the DMA controller 103 reads raster image data from the HDD 102 for printing, the read bus interface 105 forms a bottleneck, resulting in a decline in reading speed. This also results in a decline in the printing speed of the printer with a print engine, causing a decrease in the productivity of the printer. Such a decrease in the productivity which is caused by the bottleneck in reading from the HDD 102 is considerable for superfast digital printers which are used as substitutes for offset printers.

In the technique described in Patent Literature 1, whether to store the raster image data in the HDD or perform RIP processing again can be selected only on a page-by-page basis. Therefore, as for the page data to be stored in the HDD, the bottleneck in HDD reading time cannot be eliminated and the problem of productivity decrease in output of the pages to be stored in the HDD cannot be solved.

The present invention has been made in view of the above circumstances and has an object to improve the productivity of a printer.

To achieve the abovementioned object, according to an aspect of the present invention, a printing system reflecting one aspect of the present invention comprises an information processing device and a printer.

The information processing device includes: a data processor which interprets page description language data by an interpretation process performed by an arithmetic device provided in the information processing device to generate intermediate data and converts the intermediate data by a rasterization process performed by the arithmetic device to generate raster image data; a storage which stores at least either of the intermediate data and the raster image data for each page; a data format selector which stores at least either of the intermediate data and the raster image data generated by the data processor in the storage in a data format selected according to the page description language data; and an image synthesizer which sends printing image data obtained by synthesizing the raster image data obtained by conversion through the process of rasterization of the intermediate data read from the storage in the data format selected by the data format selector or the raster image data read from the storage for each page, to the printer.

The printer includes a print engine which prints an image on a recording material according to the printing image data sent from the information processing device.

The above printing system reflects one aspect of the present invention and the information processing device reflecting one aspect of the present invention and a data processing method reflecting one aspect of the present invention are configured in the same way as the above printing system.

Other issues and elements than the above will become more fully understood from the description of embodiments given hereinbelow.

### BRIEF DESCRIPTION OF THE DRAWINGS

The advantages and features provided by embodiments of the invention will become more fully understood from the detailed description given hereinbelow and the appended drawings which are given by way of illustration only, and thus are not intended as a definition of the limits of the present invention:

FIG. 1 is a block diagram which shows an example of the process in which an existing printer controller stores raster image data in an HDD;

FIG. 2 is a block diagram which shows an example of the process in which the existing printer controller reads raster image data from the HDD;

FIG. 3 is a schematic configuration diagram of the image forming system according to a first embodiment of the present invention;

FIG. 4 is a block diagram which shows an example of the internal configuration of the printer controller according to the first embodiment of the present invention;

FIG. 5 is a block diagram which shows an operation example of the printer controller according to the first embodiment of the present invention;

FIG. 6 is a flowchart which shows an example of processing by various components of the printer controller according to the first embodiment of the present invention;

FIG. 7 is an explanatory diagram which shows an example of original data layout and layout of attribute data given to a page according to the first embodiment of the present invention;

FIG. 8 is a block diagram which shows an example of the internal configuration of the printer controller according to a second embodiment of the present invention;

FIG. 9 is a table which shows the relation between the percentage of free resources of the CPU and the percentage of text/line attribute data read from the HDD according to the second embodiment of the present invention;

FIG. 10 is a block diagram which shows an operation example of the printer controller according to the second embodiment of the present invention;

FIG. 11 is an explanatory diagram which shows an example of PDL data which is divided into rectangular areas, according to a modification of the first or second embodiment of the present invention; and

FIG. 12 is a table which expresses the relation between the raster image data amount threshold versus the total data amount and the data format to be stored in the HDD, according to a modification of the first or second embodiment of the present invention.

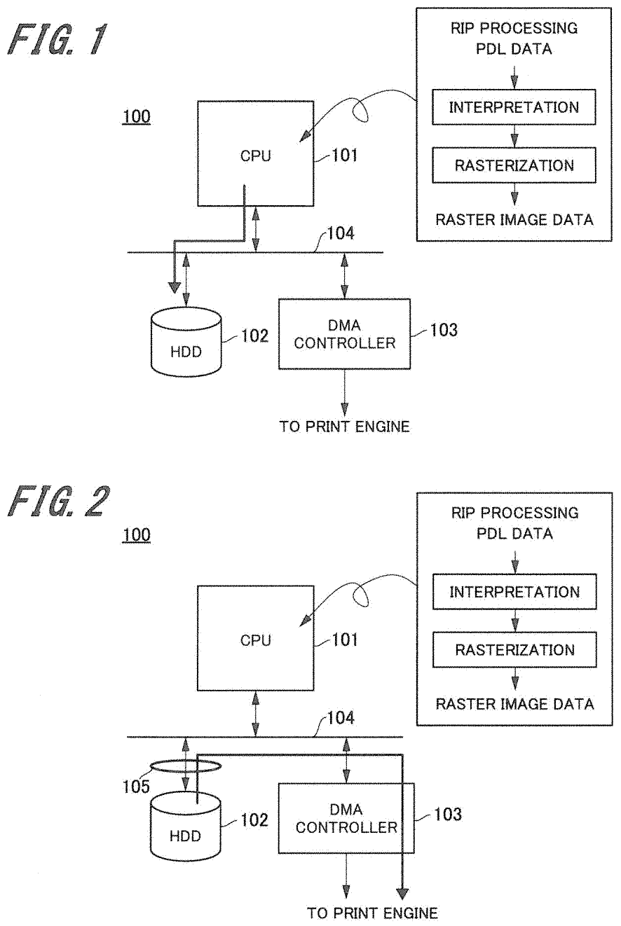

### DETAILED DESCRIPTION OF EMBODIMENTS

Hereinafter, embodiments of the present invention will be described with reference to the drawings. However, the scope of the invention is not limited to the disclosed embodiments. In this specification and drawings, constituent elements which have substantially the same functions or structures are designated by the same reference signs and their description is not repeated.

### First Embodiment

### <Configuration of the Image Forming System>

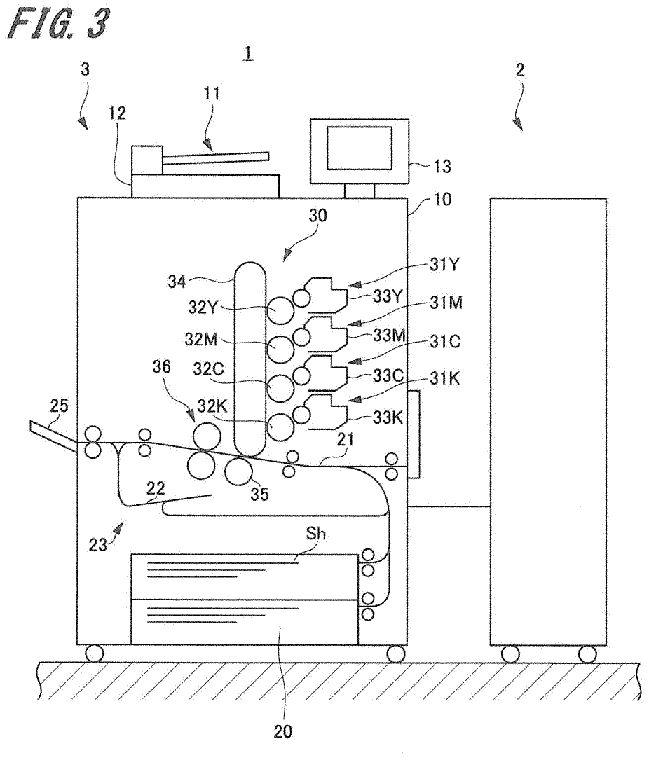

First, an example of the configuration of the image forming system according to the first embodiment of the present invention will be described referring to FIG. 3.

FIG. 3 is a schematic configuration diagram of the image forming system according to the first embodiment of the present invention. FIG. 3 shows the elements considered necessary to describe the present invention or related elements. The image forming system according to the present invention is not limited to the one shown in FIG. 3.

An image forming system 1 includes a printer controller 2 and a printer 3.

The printer controller 2 (an example of an information processing device) performs RIP processing of PDL data contained in a job entered from a client terminal (not shown) operated by a user, through a LAN (Local Area Network) (not shown). The RIP-processed image data for printing is sent from the printer controller 2 to the printer 3.

The printer 3 is an example of a printer which forms an image on a sheet Sh (an example of a recording medium) by the electrophotographic method which uses static electricity to form an image. The printer 3 adopts the tandem method in which toner images of, for example, four colors (yellow (Y), magenta (M), cyan (C), and black (K)) are superimposed to form a color image on a sheet Sh. At this time, the printer 3 selects one-side printing or double-side printing or performs aggregate printing for printing a number of pages on a single sheet, according to the printing information specified for the job.

The printer 3 includes an image input section 11 with an automatic original feeder (ADF: Automatic Document Feeder) 12, an operation display section 13, and paper feed trays 20. The printer 3 further includes a print engine 10 with an image forming section 30.

The print engine 10 controls operation of the image forming section 30 according to the printing image data sent from the printer controller 2 and prints (forms) an image on a sheet Sh.

The image input section 11 optically reads the image from an original placed on the original holder of the automatic original feeder 12 and makes A/D conversion of the read image to generate image data (scan data). The image input section 11 can also read on the platen glass.

The operation display section 13 includes a display part such as a liquid crystal panel and an operation part such as a touch sensor. The display part and operation part are integrated, for example, into a touch panel. The operation display section 13 generates an operation signal expressing the operational content which the user has entered with the operation part and supplies the operation signal to a controller in the print engine 10 which controls operation of various components of the printer 3. Furthermore, the operation display section 13 displays an operation screen containing the operational content and setting information entered by the user, according to a display signal supplied from the controller. Since the operation display section 13 is formed as a touch panel, it permits input operation on the operation screen. Therefore, the user can make a function setting through the operation screen.

Instead, the operation part may be a mouse or tablet which is separate from the operation display section 13. In this case, the user can select the operation screen displayed on the operation display section 13 through the operation part as a separate member.

Each paper feed tray 20 is a container which houses a sheet S on which an image is formed by the image forming section 30. The printer 3 can form an image even on a resin sheet as an example of a recording medium. The different paper feed trays 20 house sheets Sh which are different in paper type and basis weight. Although two paper feed trays 20 are provided in the present embodiment, instead the number of paper feed trays 20 may be one or three or more.

The printer 3 has a transportation path 21 to transport the sheet Sh supplied from the paper feed tray 20 to a paper delivery tray 25 (an example of a paper delivery section). The transportation path 21 includes a plurality of conveyor rollers to transport a sheet Sh.

The image forming section 30 includes four image forming units 31Y, 31M, 31C, and 31K for forming toner images of four colors Y, M, C, and K and forms an image on the sheet Sh. Each of the image forming units 31Y, 31M, 31C, and 31K includes an electrifying section (not shown), an exposure section (not shown), photoreceptor drums 32Y, 32M, 32C, and 32K as image carriers, and developing sections 33Y, 33M, 33C, and 33K.

The developing sections 33Y, 33M, 33C, and 33K irradiate the surfaces (outer circumferences) of the photoreceptor drums 32Y, 32M, 32C, and 32K with light according to the image to form electrostatic latent images on the circumferences of the photoreceptor drums, respectively. Then, the developing sections 33Y, 33M, 33C, and 33K make toners adhere to the electrostatic latent images to form toner images on the photoreceptor drums 32Y, 32M, 32C, and 32K.

The image forming section 30 includes an intermediate transfer belt 34, a secondary transfer section 35, and a fixing section 36. The intermediate transfer belt 34 is a belt to which the images formed on the photoreceptor drums 32Y, 32M, 32C, and 32K are transferred primarily. The secondary transfer section 35 is a roller which secondarily transfers the different color tone images primarily transferred to the intermediate transfer belt 34, to the sheet Sh transported through the transportation path 21.

The fixing section 36, located downstream of the secondary transfer section 35 in the sheet transportation direction, performs a fixing process on the sheet Sh supplied from the image forming section 30, on which the color toner image has been formed. The fixing section 36 fixes the image transferred by the image forming section 30, on the front side of the sheet Sh by heating and pressurizing the transported sheet Sh. On the downstream side of the fixing section 36, the transportation path 21 extends and joins the paper delivery tray 25.

The transportation path 21 is connected to an inversion transportation path 22 which branches off on the downstream side of the fixing section 36 and joins the transportation path 21 on the upstream side of the print engine 10. The inversion transportation path 22 includes an inversion section 23 which inverts the sheet Sh upside down.

The sheet Sh on which the image has been fixed by the fixing section 36 is transported to the paper delivery tray 25 through the transportation path 21 or made to pass through the inversion transportation path 22 and inverted by the inversion section 23 before being returned to the transportation path 21 on the upstream side of the print engine 10. An image is formed on the back side of the inverted sheet Sh by the print engine 10. Then, the sheet Sh subjected to the fixing process by the fixing section 36 is delivered to the paper delivery tray 25.

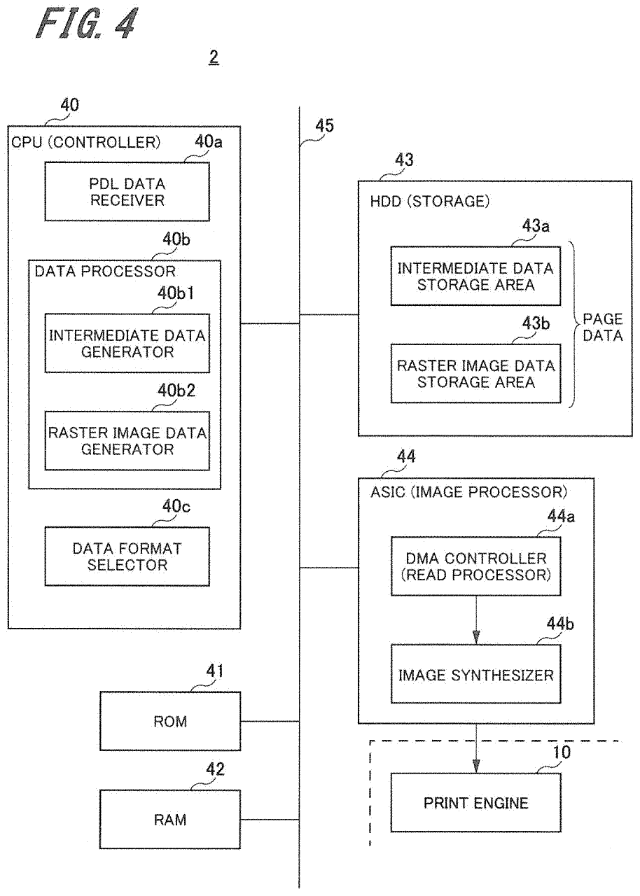

Next, an example of the configuration of the printer controller 2 and an operation example of the printer controller 2 will be explained referring to FIGS. 4 and 5.

FIG. 4 is a block diagram which shows an example of the internal configuration of the printer controller 2. FIG. 5 is a block diagram which shows an operation example of the printer controller 2.

The printer controller 2 includes a CPU 40, a ROM (Read Only Memory) 41, a RAM (Random Access Memory) 42, an HDD 43, and an ASIC (Application Specific Integrated Circuit) 44. The CPU 40, ROM 41, RAM 42, HDD 43, and ASIC 44 are all connected through a system bus 45.

The CPU 40 (an example of an arithmetic device) can perform a prescribed process by reading a program from the ROM 41 or HDD 43 and executing the program. The operation of the CPU 40 is considered as processing by the controller to control the operation of various components of the printer controller 2.

The ROM 41 stores the program to be executed by the CPU 40 or the data used to execute the program.

The CPU 40 reads the program stored in the ROM 41 to control the various components of the printer controller 2.

Variables and parameters which are generated in the course of arithmetic processing by the CPU 40 are temporarily written in the RAM 42.
The HDD 43 is an example of a large-capacity storage and used as a storage which stores intermediate data and raster image data according to the present embodiment. The HDD 43 stores not only an OS (Operating System) and various parameters but also the program to enable the computer of the printer controller 2 to function. The ROM 41 and HDD 43 permanently store the program and data required for the CPU 40 to operate and are used as an example of a non-transitory computer-readable recording medium which stores the program to be executed by the computer of the printer controller 2. As the storage, an SSD (Solid State Drive), a flexible disk, an optical disk, a magnetic optical disk, a CD-ROM, a CD-R, magnetic tape, a nonvolatile memory or the like may be used.

The CPU 40 includes a PDL data receiver 40a, a data processor 40b, and a data format selector 40c.

The PDL data receiver 40a receives the page description language data created in the page description language (PDL) (hereinafter called “PDL data”) from a client terminal (not shown) through a network such as a LAN.

The data processor 40b interprets the PDL data through the interpretation process performed by the CPU 40 to generate intermediate data and converts the intermediate data thorough the rasterization process performed by the CPU 40 to generate raster image data. Here, the data processor 40b classifies the PDL data into either image attribute (natural image) data or text or line attribute data (hereinafter called “text/line attribute data”) according to the result of analysis of the PDL data by the interpretation process. The image attribute (natural image) refers to an image such as a landscape or portrait. The data processor 40b includes an intermediate data generator 40b1 and a raster image data generator 40b2.

The intermediate data generator 40b1 and raster image data generator 40b2 perform RIP processing. PDL data is converted into raster image data by RIP processing. As mentioned above, RIP processing is performed in two steps, namely an interpretation process and a rasterization process. Then, according to the PDL data, the following interpretation process and rasterization process are performed sequentially for each image attribute.

Here, the intermediate data generator 40b1 generates intermediate data by performing the process to interpret the PDL data. In the interpretation process, the page description language data is analyzed so that the position of an object such as text is identified, the object is outlined, and a font is called, and then intermediate data is generated.

The raster image data generator 40b2 generates raster image data by performing the process to rasterize the intermediate data. In the rasterization process, the intermediate data is converted into raster image data for each pixel according to the resolution of the print engine 10.

The data format selector 40c selects the data format to store at least either of the intermediate data and raster image data generated by the data processor 40b in the HDD 43, in the data format selected according to the PDL data. Here, the data format selector 40c selects the data format to be stored in the HDD 43 according to the predetermined attribute information for each page.

For example, if PDL data has a text/line attribute, the data format selector 40c selects the intermediate data format as the data format to be stored in the HDD 43. On the other hand, if PDL data has an image attribute (natural image), the data format selector 40c selects the raster image data format as the data format to be stored in the HDD 43. The data format selector 40c may select the data format on a page-by-page basis.

The HDD 43 stores at least either of intermediate data and raster image data for each page. Therefore, the HDD 43 includes an intermediate data storage area 43a and a raster image data storage area 43b. In the intermediate data storage area 43a, the text/line attribute intermediate data among the intermediate data generated by the intermediate data generator 40b1 is stored. In the raster image data storage area 43b, the image attribute (natural image) raster image data among the raster image data generated by the raster image data generator 40b2 is stored.

As mentioned above, text/line attribute PDL data is stored as intermediate data in the HDD 43. Image attribute (natural image) PDL data are subjected to the interpretation process and rasterization process and the PDL data subjected to these processes is converted into raster image data and stored in the HDD 43. The intermediate data and raster image data which are stored in the HDD 43 may be collectively called page data. The page data is managed inside the HDD 43 on a job-by-job basis and on a page-by-page basis.

If the data format selector 40c selects the raster image data format as the data format to be stored in the HDD 43, the data processor 40b may make the resolution of raster image data to be stored in the HDD 43 lower than the normal raster image data resolution. By doing so, the raster image data generated from the image attribute (natural image) PDL data is stored with the lower resolution in the HDD 43. Since the spatial frequency of image attribute (natural image) PDL data is low, even if the resolution is lower than the original image resolution, the image quality does not deteriorate so much.

PDL data includes a text/line attribute image area and an image attribute image area. After the interpretation process is performed in the intermediate data generator 40b1, the data format selector 40c selects either the intermediate data format or the raster image data format as the data format to be stored in the HDD 43 for each image area.

The HDD 43 may store a plurality of intermediate data and a plurality of raster image data for each page.

The ASIC 44 is an integrated circuit for image processing according to the present embodiment and used as an example of an image processing section. The ASIC 44 includes a DMA controller 44a (an example of a read processor) and an image synthesizer 44b.

In the printing process, the DMA controller 44a reads raster image data from the HDD 43. If the data format selector 40c selects the raster image data format as the data format to be read from the HDD 43, the DMA controller 44a reads raster image data from the HDD 43 and sends it to the image synthesizer 44b.

Here, text/line data has been stored as intermediate data in the HDD 43. Therefore, if the data format selector 40c selects the intermediate data format as the data format to be read from the HDD 43, the data processor 40b reads intermediate data from the HDD 43. Then, the data processor 40b (raster image data generator 40b2) generates raster image data by conversion of the read intermediate data through the rasterization process. Then, the data processor 40b sends the raster image data to the image synthesizer 44b through the DMA controller 44a.

Since the image attribute data has been stored as rasterized raster image data in the HDD 43, the DMA controller 44a sends the raster image data read from the HDD 43 to the image synthesizer 44b directly without a data conversion process (for example, a rasterization process).

The image synthesizer 44b obtains printing image data by synthesizing the raster image data obtained by conversion through the process of rasterization of the intermediate data read from the HDD 43 in the data format selected by the data format selector 40c or the raster image data read from the HDD 43 for each page. Then, the image synthesizer 44b sends the printing image data to the printer 3 at a prescribed transfer speed. For this purpose, the image synthesizer 44b synthesizes the data received from the DMA controller 44a and generates printing image data in the bitmap format which allows the print engine 10 to print the data. Then, the image synthesizer 44b sends the generated printing image data to the print engine 10. Then, the print engine 10 forms an image on the sheet Sh according to the received printing image data and performs a series of printing steps to fix the image on the sheet Sh.

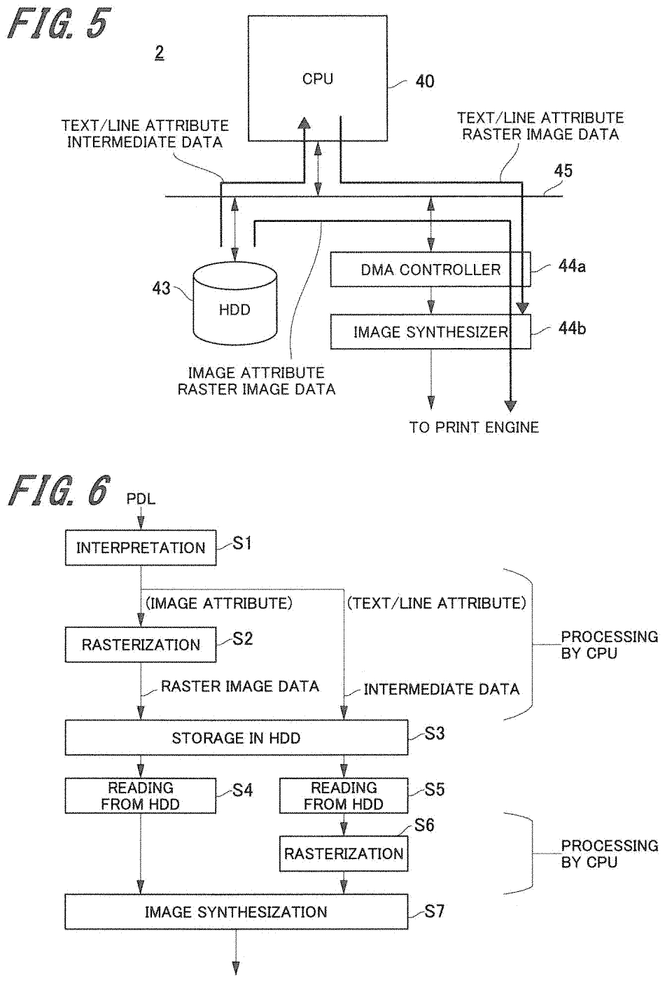

FIG. 6 is a flowchart which shows an example of processing by various components of the printer controller 2. The processing steps differ depending on whether the PDL data received by the printer controller 2 is image attribute (natural image) data or text/line attribute data.

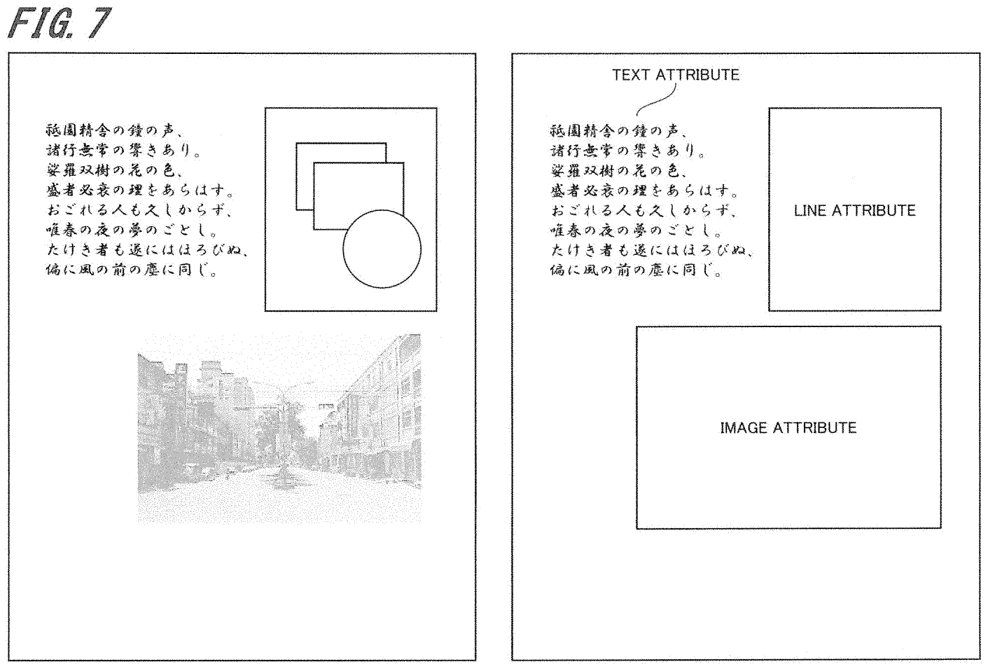

First, the processing steps from conversion of PDL data to storage in the HDD 43 will be explained. As mentioned above, as the CPU 40 performs the process to interpret the PDL data received by the PDL data receiver 40a, intermediate data is generated. This intermediate data is given attribute data representing the text, line or image attribute which is determined in a page by the CPU 40 (intermediate data generator 40b1). The attribute data given to the page and an example of arrangement of areas to which the attribute data has been given are explained below referring to FIG. 7.

FIG. 7 is an explanatory diagram which shows an example of original data layout (called “original layout”) and layout of attribute data given to a page in the original data after the interpretation process (called “attribute layout”). The original data shown in FIG. 7 is visualized PDL data.

The original layout shown on the left in FIG. 7 shows an example of arrangement of text and the like contained in one page of the original data. In this original layout, the text lies in a left upper area of the page, a graphic containing a circle and rectangles overlapping each other lies in a right upper area of the page, and a landscape photograph lies in a lower area of the page.

The attribute layout shown on the right in FIG. 7 shows an example of arrangement of attribute data given after the process to interpret the original data (PDL data) shown in the original layout. Text attribute data is given to the area corresponding to the area in the original layout where the text lies and line attribute data is given to the area corresponding to the area where the graphic lies. Also, image attribute data is given to the area corresponding to the area in the original layout where the landscape photograph lies. Attribute data for various attributes are given to the page in this way.

The explanation below is given referring back to FIG. 6.

The intermediate data generator 40b1 performs the process to interpret the received PDL data (S1) to generate intermediate data. Then, the intermediate data generator 40b1 gives the image attribute data or text/line attribute data to the intermediate data. As explained above referring to FIG. 7, the image attribute or text/line attribute data is given to the intermediate data according to the corresponding image or text/line area in the PDL data (original data).

As the image attribute data is given to the intermediate data, the raster image data generator 40b2 performs the process to rasterize the image attribute intermediate data (S2) to generate raster image data. Then, the raster image data generator 40b2 stores the image attribute raster image data in the raster image data storage area 43b (S3).

On the other hand, as text/line attribute data is given to the intermediate data, the intermediate data generator 40b1 directly stores the intermediate data generated by the interpretation process in the intermediate data storage area 43a of the HDD 43 (S3). Steps S1 and S2 are both carried out by the CPU 40. According to the present embodiment, the steps (S1 to S3) taken for the intermediate data which has an image attribute or text/line attribute are selected according to the attribute data given to the page.

Next, the processing steps for printing will be explained.

As the data format selector 40c selects the raster image data format as the data format to be read, the DMA controller 44a reads the image attribute raster image data from the raster image data storage area 43b of the HDD 43 (S4) and sends the read raster image data to the image synthesizer 44b.

On the other hand, as the data format selector 40c selects the intermediate data format as the data format to be read, the raster image data generator 40b2 of the CPU 40 reads text/line attribute intermediate data from the intermediate data storage area 43a of the HDD 43 (S5) and performs the process to rasterize the intermediate data (S6). Then, the raster image data generator 40b2 sends the generated raster image data to the DMA controller 44a. The DMA controller 44a sends the text/line attribute raster image data to the image synthesizer 44b.

The image synthesizer 44b synthesizes the image attribute raster image data and text/line attribute raster image data received from the DMA controller 44a to generate printing image data (S7). Then, the image synthesizer 44b sends the printing image data to the print engine 10. This concludes the processing sequence by the printer controller 2.

The printer controller 2 according to the first embodiment as explained above changes the processing sequence to perform the rasterization process after the interpretation process according to the attribute of PDL data. Since the amount of intermediate data generated by interpretation of text/line attribute PDL data is smaller than the amount of raster image data, the time required for reading from the HDD 43 can be shortened. In addition, since PDL data is subjected to the interpretation process in advance, in the printing process the interpretation process can be omitted and thus the time required for the printer 3 to start printing can be shortened.

Since the data read from the HDD 43 is intermediate data and the amount of intermediate data is smaller, the load of access to the HDD 43 is reduced. In addition, since part of the data is already stored as raster image data in the HDD 43, the load of interpretation and rasterization after reading from the HDD 43 is lower. Therefore, the speed of transfer of printing image data to the printer 3 is increased and thus the productivity of the printer 3 is improved.

At the start of printing, pre-RIP processing has already been finished by the CPU 40. Therefore, at the start of printing, the CPU 40 need not perform high-load processing (for example, RIP processing of image attribute PDL data). Therefore, the CPU 40 affords to rasterize the intermediate data for some (limited to text or line areas) of the areas read from the HDD 43. The load of rasterization of text/line attribute intermediate data on the CPU 40 is lower than the load of rasterization of image attribute intermediate data on the CPU 40. Therefore, the CPU 40 can complete the process to rasterize text/line attribute intermediate data, in a shorter time.

### Second Embodiment

Next, the processing steps taken by the printer controller according to the second embodiment of the present invention will be explained.

In the above printer controller 2 according to the first embodiment, the data format to be read from the HDD 43 is selected according to the attribute of PDL data in a fixed manner. If the intermediate data format is used to read, the rasterization process is required as mentioned above and the resources of the CPU 40 are consumed. In addition, in the printer controller 2 according to the first embodiment, at the time when RIP processing is first performed, either the raster image format or the intermediate data format is selected as the data format to be stored in the HDD 43.

Although the first embodiment assumes that the resources of the CPU 40 are used only for printing, another task may be assigned to the CPU 40: for example, RIP processing for another job must be performed concurrently with printing operation. Unless sufficient resources of the CPU 40 are allocated to the rasterization process, if the data read from the HDD 43 is intermediate data, it would take longer time to rasterize the intermediate data. As a result, the printing speed of the printer 3 would decrease, resulting in a decline in the productivity. Therefore, a printer controller 2A according to the second embodiment is intended to optimize the printing speed according to the condition of the CPU 40.

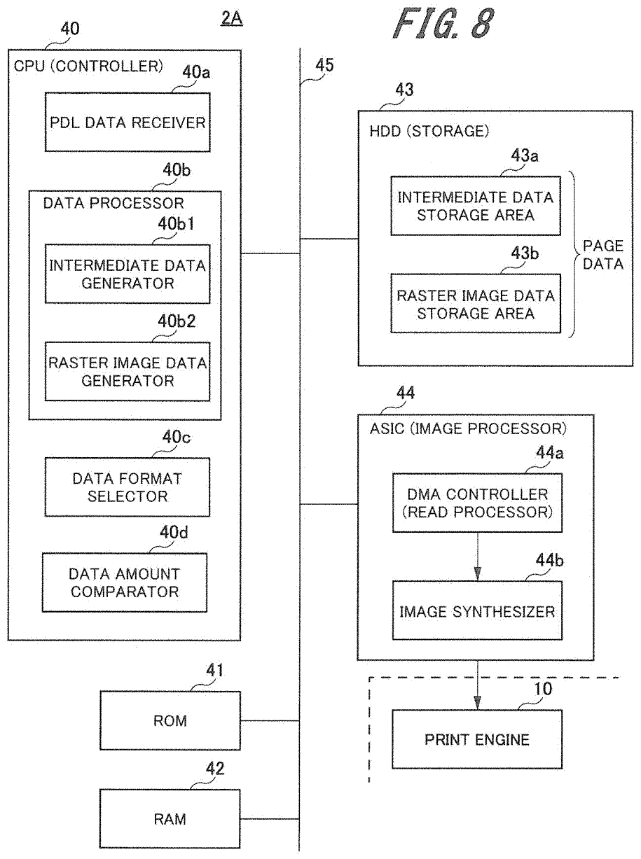

Next, an example of the configuration of the printer controller 2A and an operation example of the printer controller 2A will be explained referring to FIGS. 8 to 10.

FIG. 8 is a block diagram which shows an example of the internal configuration of the printer controller 2A.

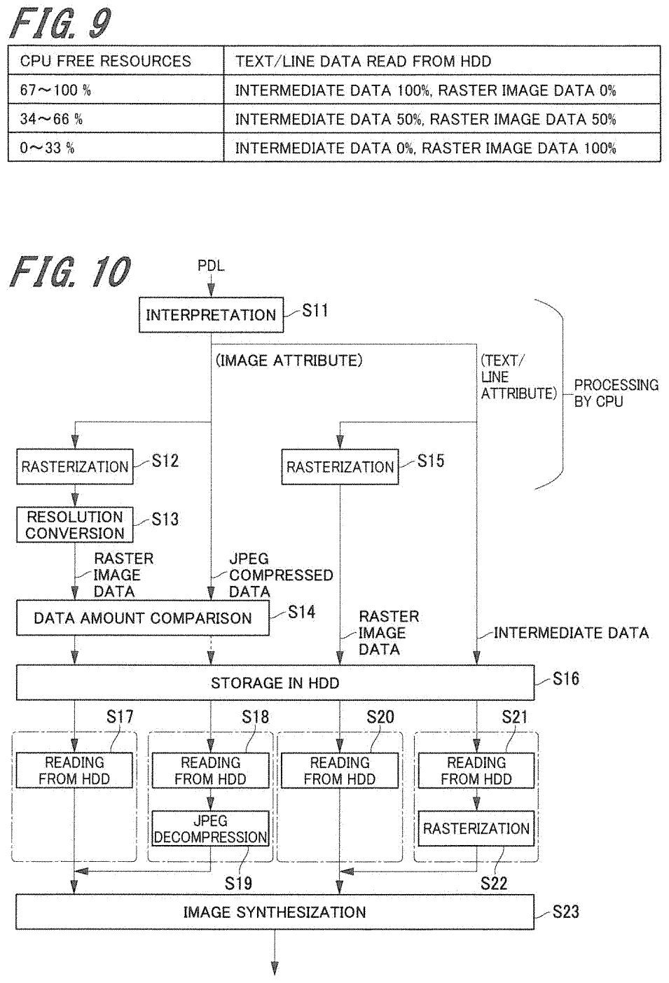

FIG. 9 is a table which shows the relation between the percentage of free resources of the CPU 40 and the percentage of text/line attribute data read from the HDD 43.

FIG. 10 is a block diagram which shows an operation example of the printer controller 2A.

The printer controller 2A includes the same elements as those of the printer controller 2 as mentioned above and the CPU 40 further includes a data amount comparator 40d. The printer controller 2A changes the data format to be stored in the HDD 43 and the data format to be read from the HDD 43 according to the condition of the CPU 40. The condition of the CPU 40 here refers to, for example, the load which is applied to the CPU 40 when the data processor 40b performs the rasterization process and the amount of the data which is processed by the CPU 40.

The data amount comparator 40d makes a comparison about at least either of the load which is applied to the CPU 40 and the amount of the data which is processed by the CPU 40, for each given unit and outputs a comparison result. For example, the data amount comparator 40d makes a comparison about the amount of intermediate data generated by the intermediate data generator 40b1, as data which is processed by the CPU 40.

Then, the data format selector 40c selects the data format to be read from the HDD 43 for each specific area in a page according to the free resources of the CPU 40. Specifically, the data format selector 40c selects, for each page, whether the data format should be the format only for intermediate data or only for raster image data or for combination of intermediate data and raster image data.

In the case of text/line attribute PDL data, the data format selector 40c according to the present embodiment selects the data format so that both intermediate data and raster image data are stored in the HDD 43 at the time of pre-RIP processing. Here, for storage of data, the data format selector 40c selects the data format to be stored in the HDD 43 for each attribute according to the result of comparison made by the data amount comparator 40d for each page attribute.

In addition, in the printing process, the data format selector 40c selects whether to read the text/line attribute data from the HDD 43 in the intermediate data format or in the raster image data format or in combination of both, in consideration of the free resources of the CPU 40 allocated to the rasterization process for printing.

As shown in FIG. 9, the data format selector 40c determines what percentage is allocated to read the text/line attribute data as intermediate data, according to the percentage (availability) of free resources of the CPU 40. If the percentage of free resources of the CPU 40 is high, the percentage for intermediate data is increased and if the percentage of free resources of the CPU 40 is low, the percentage for raster image data is increased.

For example, if the percentage of free resources of the CPU 40 is 0 to 33%, almost all the resources of the CPU 40 are being used for another task, so the percentage to read text/line attribute data as raster image data from the HDD 43 is determined as 100%. If the percentage of free resources of the CPU 40 is 34 to 66%, a lower percentage of the resources of the CPU 40 are being used for another task, so the percentage to read text/line attribute data as intermediate data from the HDD 43 is determined as 50% and the percentage to read text/line attribute data as raster image data from the HDD 43 is determined as 50%. If the percentage of free resources of the CPU 40 is 67% to 100%, virtually none of the resources of the CPU 40 are being used for another task, so the percentage to read text/line attribute data as intermediate data from the HDD 43 is determined as 100%.

On the other hand, as for image attribute data, at the time of pre-RIP processing, the data format selector 40c stores both the JPEG (Joint Photographic Experts Group) compressed data derived from PDL data and data obtained by resolution conversion of raster image data in the HDD 43. In the present embodiment, intermediate data includes data in compressed data format which is embedded in PDL data.

In the printing process, the data format selector 40c selects the data format to be read from the HDD 43 between the JPEG compressed data format and the raster image data format according to information on free resources of the CPU 40 as in the case of text/line attribute data. If the data format selector 40c selects to read the JPEG compressed data from the HDD 43, it decompresses the JPEG data using the resources of the CPU 40 as in the case of intermediate data. Instead, decompression of JPEG data may be performed by the raster image data generator 40b2.

As for image attribute data, in some cases the amount of JPEG compressed data is larger than that of resolution-converted raster image data. Therefore, at the time of pre-RIP processing, if the amount of JPEG compressed data is larger than that of resolution-converted raster image data, the data format selector 40c determines to store only the resolution-converted data in the HDD 43. Consequently, the HDD 43 stores the resolution-converted data whose amount is smaller.

FIG. 10 is a flowchart which shows an example of processing by various components of the printer controller 2A. Also in the second embodiment, the processing steps taken by the data processor 40b differ depending on whether the PDL data received by the printer controller 2A is image attribute (natural image) data or text/line attribute data.

First, the steps from conversion of PDL data to storage in the HDD 43 will be explained.

As the PDL data receiver 40a receives PDL data, the intermediate data generator 40b1 performs the process to interpret the PDL data (S11) to generate intermediate data. Then, the intermediate data generator 40b1 gives image attribute data or text/line attribute data to the intermediate data. If the intermediate data is data to which image attribute data has been given, the intermediate data generator 40b1 extracts the JPEG compressed data embedded in the PDL data.

Next, the raster image data generator 40b2 performs the process to rasterize the image attribute intermediate data (S12) to generate raster image data and further converts the resolution of the raster image data (S13).

The data amount comparator 40d compares the JPEG compressed data extracted at Step S11 and the raster image data whose resolution has been converted at Step S13, in terms of data amount (S14). Then, the data amount comparator 40d stores the JPEG compressed data or raster image data, whichever is smaller in data amount, in the HDD 43 (S16).

On the other hand, if the intermediate data subjected to the interpretation process at Step S11 is text/line attribute data, the raster image data generator 40b2 performs the process to rasterize the intermediate data (S15) to generate raster image data. Then, in the case of text/line attribute data, the data format selector 40c selects the intermediate data format and the raster image data format as the data format to be stored in the HDD 43, so that the intermediate data and raster image data are both stored in the HDD 43 (S16).

Next, the printing process will be explained.

Whether to take either Step S17 or Steps S18 and S19 is determined by the data format selector 40c of the CPU 40. Also, whether to take either Step S20 or Steps S21 and S22 is determined by the data format selector 40c of the CPU 40.

The data format selector 40c selects whether to send the data read from the HDD 43 to the DMA controller 44a or make the CPU 40 process the data once, according to information on free resources of the CPU 40. When processing the image attribute data, if free resources of the CPU 40 are unavailable, namely the load on the CPU 40 is high, according to the determination by the data format selector 40c, the DMA controller 44a sends the image attribute raster image data read from the HDD 43 to the image synthesizer 44b (S17).

If free resources of the CPU 40 are available, namely the load on the CPU 40 is low, the CPU 40 reads the JPEG compressed data from the HDD 43 (S18) and decompresses the JPEG data (S19) before sending the image attribute raster image data to the DMA controller 44a. Then the DMA controller 44a sends the image attribute raster image data to the image synthesizer 44b.

When processing the text/line attribute data, if free resources of the CPU 40 are unavailable, namely the load on the CPU is high, according to the determination by the data format selector 40c, the DMA controller 44a sends the text/line attribute raster image data read from the HDD 43 to the image synthesizer 44b (S20).

If free resources of the CPU 40 are available, namely the load on the CPU 40 is low, the CPU 40 reads the intermediate data from the HDD 43 (S21) and the raster image data generator 40b2 performs the process to rasterize the intermediate data (S22). Then, the CPU 40 sends the text/line attribute raster data to the DMA controller 44a. Then, the DMA controller 44a sends the text/line attribute raster image data to the image synthesizer 44b.

After that, the image synthesizer 44b synthesizes the image attribute raster image data and text/line attribute raster image data received from the DMA controller 44a to generate printing image data (S23). Then, the image synthesizer 44b sends the printing image data to the print engine 10. This concludes the processing sequence by the printer controller 2A.

In the printer controller 2A according to the second embodiment as explained above, the percentage to convert the text/line attribute PDL data into intermediate data and the percentage to convert the text/line attribute PDL data into raster image data are determined according to the size of free resources of the CPU 40. Therefore, since the amount of intermediate data stored in the HDD 43 is smaller, the amount of intermediate data read from the HDD 43 may be smaller. In addition, when the intermediate data generated from the text/line attribute PDL data is rasterized, the load on the CPU 40 is decreased, thereby preventing an excessive load from being applied to the CPU 40 for printing.

Furthermore, if the data has already been converted into raster image data by pre-RIP processing, the DMA controller 44a reads the raster image data directly from the HDD 43 and sends it to the image synthesizer 44b. Therefore, the overall processing time can be shorter than when intermediate data generated from 100% of text/line attribute PDL data is read from the HDD 43 and rasterized by the CPU 40.

In addition, image attribute PDL data is subjected to the interpretation process and rasterization process. In the case of resolution-converted raster image data, the data processor 40b has already lowered the resolution, so the data amount is smaller than the amount of intermediate data. This also shortens the time required to read image attribute raster image data from the HDD 43.

Alternatively, the data format of data to be read from the HDD 43 may be selected for each of a plurality of areas in a page, according to free resources (load) of the CPU 40. For example, if free resources of the CPU 40 are unavailable, the DMA controller 44a reads raster image data from the HDD 43 for a certain area in a page. If the CPU 40 finishes another task while reading the raster image data and free resources of the CPU 40 are increased, the CPU 40 may read JPEG compressed data or intermediate data from the HDD 43 and decompress the JPEG data or perform the rasterization process.

### Modifications

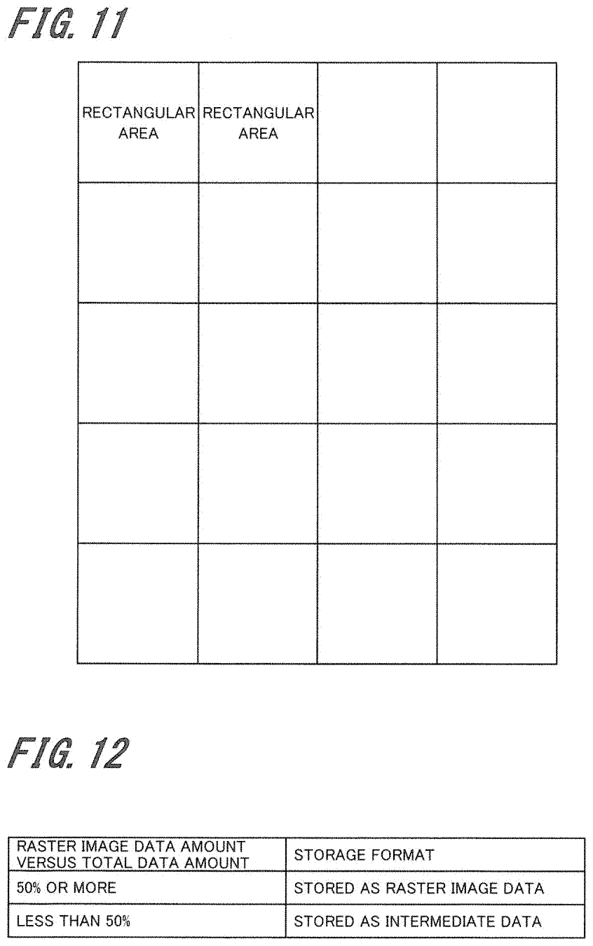

Next, modifications of the first and second embodiments will be described referring to FIGS. 11 and 12.

Since it is desirable that the amount of data which is stored in the HDD 43 be smaller, it is desirable to store most of image data as intermediate data. On the other hand, when image data is stored as intermediate data, conversion of the intermediate data into raster image data is required in the printing process.

However, if data conversion is performed for all areas in each page, a considerable load would be applied to the CPU 40 and the load might cause a decrease in printing speed. Therefore, the data format selector 40c selects the data format to be stored in the HDD 43 for each specific area according to the result of comparison made by the data amount comparator 40d for each specific area in a page. For example, the data format selector 40c stores the data only for an area for which the amount of intermediate data is small, as intermediate data, and for an area for which the amount of intermediate data is relatively large, the data is rasterized previously and the data format is selected so that the raster image data is stored in the HDD 43.

FIG. 11 is an explanatory diagram which shows an example of PDL data which is divided into rectangular areas.

The PDL data which constitutes one image can be divided into rectangular areas with a given size. Then, the data format selector 40c determines whether the amount of raster image data obtained by the interpretation and rasterization processes for each rectangular area is less than a prescribed threshold or not less than the prescribed threshold.

FIG. 12 is a table which shows the relation between the raster image data amount threshold versus the total data amount and the data format to be stored in the HDD 43.

If the data format selector 40c determines that the percentage of the raster image data amount versus the total data amount for a rectangular area is less than 50%, the data format selector 40c selects the data format so that the rectangular area is stored as intermediate data in the HDD 43. On the other hand, if the data format selector 40c determines that the percentage of the raster image data amount versus the total data amount for the rectangular area is 50% or more, the data format selector 40c selects the data format so that the rectangular area is stored as raster image data in the HDD 43.

When the data format selector 40c changes the data format of page data to be stored in the HDD 43 for each rectangular area as explained above, the amount of page data which is stored in the HDD 43 can be decreased. Consequently, the amount of page data read from the HDD 43 can also be decreased. All the page data that has been read from the HDD 43 is not intermediate data. In other words, intermediate data and raster image data are mixed in the page data, so the load on the CPU 40 in rasterization of intermediate data can be reduced.

Alternatively, according to the result of comparison made by the data amount comparator 40d for each object unit which represents a block of drawing expressions in a page, the data format selector 40c may select the data format to be stored in the HDD 43 for each object unit.

Furthermore, the data format selector 40c may select the data format to be stored in the HDD 43 according to the intermediate data amount calculated for each piece of attribute information previously given to a page.

Furthermore, the data format selector 40c may select the data format of intermediate data or raster image data, whichever is smaller in data amount, as the data format to be stored in the HDD 43, according to the relative value of intermediate data or raster image data which has been compared by the data amount comparator 40d.

In the above first and second embodiments, the printer controller 2 and the printer 3 are separate from each other. However, instead the printer 3 may have the function of the printer controller 2. If that is the case, the printer 3 can perform the PDL data conversion process and the like by itself. The client terminal (not shown) or the cloud server on the Internet which is connected to the printer 3 may bear the function of the printer controller 2.

The present invention is not limited to the above embodiments. Obviously, the present invention may be embodied and applied in other various ways without departing from the gist of the invention as described in the appended claims.

For example, in the above embodiments, the device and system configurations have been described in detail and concretely for easy understanding of the present invention; however, the present invention is not limited to a configuration which includes all the elements described above. An element of the abovementioned embodiments may be replaced by an element of another embodiment or an element of one embodiment may be added to another embodiment. For each embodiment, addition, deletion, or replacement of an element can be made.

The control lines and data lines shown herein are those considered as required for explanation and do not cover all the control lines and data lines in the product. It may be considered that almost all constituent elements are connected to each other actually.

Although embodiments of the present invention have been described and illustrated in detail, the disclosed embodiments are made for purposes of illustration and example only and not limitation. The scope of the present invention should be interpreted by terms of the appended claims.

### REFERENCE SIGNS LIST

1 . . . image forming system,
2 . . . printer controller,
3 . . . printer,
10 . . . print engine,
40 . . . CPU,
40a . . . PDL data receiver,
40b . . . data processor,
40b1 . . . intermediate data generator,
40b2 . . . raster image data generator,
40c . . . data format selector,
40d . . . data amount comparator,
43 . . . HDD,
43a . . . intermediate data storage area,
43b . . . raster image data storage area,
44 . . . ASIC,
44a . . . DMA controller,
44b . . . image synthesizer

What is claimed is:

1. A printing system comprising an information processing device and a printer,
the information processing device comprising:
a data processor which interprets page description language data by an interpretation process performed by an arithmetic device provided in the information processing device to generate intermediate data and converts the intermediate data by a rasterization process performed by the arithmetic device to generate raster image data;
a storage which stores at least either of the intermediate data and the raster image data for each page;
a data format selector which stores at least either of the intermediate data and the raster image data generated by the data processor in the storage in a data format selected according to the page description language data and selects the data format to be read from the storage; and
an image synthesizer which sends printing image data obtained by synthesizing the raster image data obtained by conversion through the process of rasterization of the intermediate data read from the storage in the data format selected by the data format selector or the raster image data read from the storage for each page, to the printer, and
the printer comprising:
a print engine which prints an image on a recording material according to the printing image data sent from the information processing device.

2. The printing system according to claim 1, further comprising:
a read processor which, if the data format selector selects the raster image data as the data format to be read from the storage, reads the raster image data from the storage and sends the raster image data to the image synthesizer.

3. The printing system according to claim 2, wherein, when the data format selector selects the intermediate data as the data format to be read from the storage, the data processor generates the raster image data by conversion through the process of rasterization of the intermediate data read from the storage and sends the raster image data to the image synthesizer through the read processor.

4. The printing system according to claim 3, wherein, when the data format selector selects the raster image data as the data format to be stored in the storage, the data processor performs a process to make a resolution of the raster image data to be stored in the storage lower than a normal resolution of the raster image data.

5. The printing system according to claim 1, wherein the data processor classifies the page description language data into either an image attribute or a text or line attribute according to a result of analysis of the page description language data by the interpretation process.

6. The printing system according to claim 1, wherein the data format selector selects the data format to be stored in the storage according to attribute information predetermined for each of the pages.

7. The printing system according to claim 1, wherein the intermediate data includes data in a compressed data format which is embedded in the page description language data.

8. The printing system according to claim 1, wherein
conditions of the arithmetic device include a load which is applied to the arithmetic device when the data processor performs the rasterization process, and a data amount of data processed by the arithmetic device, and
the system further comprises a data amount comparator which makes a comparison about at least either of the load and the data amount for each given unit and outputs a result of the comparison.

9. The printing system according to claim 8, wherein according to the result of the comparison made by the data amount comparator for each of attributes of the page, the data format selector selects the data format to be stored in the storage for each of the attributes.

10. The printing system according to claim 8, wherein according to a relative value of the intermediate data or the raster image data as compared by the data amount comparator, the data format selector selects the data format of the intermediate data or the raster image data, whichever is smaller in the data amount, as the data format to be stored in the storage.

11. The printing system according to claim 8, wherein according to the result of the comparison made by the data amount comparator for each of specific areas in the page, the data format selector selects the data format to be stored in the storage for each of the specific areas.

12. The printing system according to claim 8, wherein according to the result of the comparison made by the data amount comparator for each object unit which represents a block of drawing expressions in the page, the data format selector selects the data format to be stored in the HDD for each of the object units.

13. The printing system according to claim 1, wherein according to information on free resources of the arithmetic device, the data format selector selects the data format to be read from the storage for each of specific areas in the page.

14. An information processing device comprising:
a data processor which interprets page description language data by an interpretation process performed by an arithmetic device to generate intermediate data and converts the intermediate data by a rasterization process performed by the arithmetic device to generate raster image data;
a storage which stores at least either of the intermediate data and the raster image data for each page;
a data format selector which stores at least either of the intermediate data and the raster image data generated by the data processor in the storage in a data format selected according to the page description language data and selects the data format to be read from the storage; and
an image synthesizer which sends printing image data obtained by synthesizing the raster image data obtained by conversion through the process of rasterization of the intermediate data read from the storage in the data format selected by the data format selector or the raster image data read from the storage for each page, to a printer.

15. A data processing method which uses a non-transitory computer-readable storage medium storing a program causing a computer to perform:
interpreting page description language data by an interpretation process performed by an arithmetic device to generate intermediate data and converting the intermediate data by a rasterization process performed by the arithmetic device to generate raster image data;
storing at least either of the intermediate data and the raster image data for each page in a storage in a data format selected according to the page description language data;
selecting the data format to be read from the storage; and
sending printing image data obtained by synthesizing the raster image data obtained by conversion through the process of rasterization of the intermediate data read from the storage in the selected data format or the raster image data read from the storage for each page, to a printer.
